(19) United States
(12) Patent Application Publication
(10) Pub. No.: US 2018/0150145 A1
(43) Pub. Date: May 31, 2018

(54) Passive Display Accessory and Corresponding Systems and Methods

(71) Applicant: Motorola Mobility LLC, Chicago, IL (US)

(72) Inventor: Mark Frederick Valentine, Kenosha, WI (US)

(21) Appl. No.: 15/365,456

(22) Filed: Nov. 30, 2016

(51) Int. Cl. G06F 3/03; G06F 3/046

(52) U.S. Cl. CPC G06F 3/0321; G06F 3/046

(57) ABSTRACT

A passive display accessory for an electronic device includes an image transmission portion, a base having an optically transparent major face, and a body coupling the base to the image transmission portion. The body can include one or more optical transmission devices delivering light received at the optically transparent major face to the image transmission portion. Additionally, the base can include one or more electrically conductive elements disposed along the optically transparent major face in a predefined pattern to identify the passive display accessory, its location, its geometric orientation in three-dimensional space, or combinations thereof to an electronic device.

### BACKGROUND

### Technical Field

This disclosure relates generally to electronic device accessories, and more particularly to electronic device display accessories.

### Background Art

Portable electronic devices, such as smartphones or tablet computers, are becoming ubiquitous as they are used by billions of people. These electronic devices are used for many different purposes including, but not limited to, voice communications and data communications for text messaging, Internet browsing, commerce such as banking, and social networking.

As the technology of these devices has advanced, so too has their feature set. For example, not too long ago all electronic devices had physical keypads. Today touch sensitive displays are more frequently seen as user interface devices. Similarly, it used to be that the only way to deliver user input to a device was with touch, either through a keypad or touch sensitive display. Today some devices are equipped with voice recognition that allows a user to speak commands to a device instead of typing them.

These smaller, yet more powerful, devices are being used for many different applications in many different environments. It would be advantageous to have accessory devices that extend the operating modes of an electronic device to provide a richer user experience.

### BRIEF DESCRIPTION OF THE DRAWINGS

FIG. 1 illustrates one explanatory passive display accessory and one explanatory electronic device in accordance with one or more embodiments of the disclosure.

FIG. 2 illustrates one explanatory passive display accessory proximately disposed with a display of one explanatory electronic device in accordance with one or more embodiments of the disclosure.

FIG. 3 illustrates one explanatory schematic block diagram of one explanatory electronic device in accordance with one or more embodiments of the disclosure.

FIG. 4 illustrates one explanatory passive display accessory in accordance with one or more embodiments of the disclosure.

FIG. 5 illustrates one explanatory attachment layer for a passive display accessory in accordance with one or more embodiments of the disclosure.

FIG. 6 illustrates one explanatory system in accordance with one or more embodiments of the disclosure.

FIG. 7 illustrates another explanatory passive display accessory operating in another explanatory system in accordance with one or more embodiments of the disclosure.

FIG. 8 illustrates another explanatory passive display accessory in accordance with one or more embodiments of the disclosure.

FIG. 9 illustrates another explanatory passive display accessory in accordance with one or more embodiments of the disclosure.

FIG. 10 illustrates another explanatory passive display accessory in accordance with one or more embodiments of the disclosure.

FIG. 11 illustrates one explanatory method in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWING

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. As used herein, components may be “operatively coupled” when information can be sent between such components, even though there may be one or more intermediate or intervening components between, or along the connection path. The terms “substantially” and “about” are used to refer to dimensions, orientations, or alignments inclusive of manufacturing tolerances. Thus, a “substantially orthogonal” angle with a manufacturing tolerance of plus or minus two degrees would include all angles between 88 and 92, inclusive. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide a passive display accessory operable with a display of an electronic device. In one embodiment, the passive display accessory includes an image transition portion that transmits light out of the passive display accessory to deliver an image to a user. A body couples a base having an optically transparent major face to the image transmission portion. One or more optical transmission devices deliver light received at the optically transparent major face of the base to the image transmission portion. Accordingly, when the base of the passive display accessory is placed on a display, and the display presents an image beneath the optically transparent major face, light defining the image is translated through the optical transmission devices to the image transmission portion. A user can then see the image on the image transmission portion.

Advantageously, when the passive display accessory is configured as a figurine or a game piece, the display can present, for example, the image of a face beneath the game piece. The optical transmission devices then translate the light of the image to the image transmission portion. A user can then see the image on the image transmission portion. Accordingly, the user sees the image of the face on the passive display accessory.

In one or more embodiments, the passive display accessory includes one or more electrically conductive elements disposed along the optically transparent major face. In one or more embodiments, these electrically conductive elements are disposed along the optically transparent major face in a predefined pattern. In one embodiment, the predefined pattern identifies the passive display accessory. For example, if the passive display accessory is configured as a pawn chess piece, the predefined pattern can identify this fact. In another embodiment, the predefined pattern can identify a location of the passive display accessory along the display. In another embodiment, the predefined pattern can identify a geometric orientation in three-dimensional space of the passive display accessory along an axis oriented substantially orthogonally with the display. Of course, the predefined pattern can identify a combination of these characteristics as well. Other identifiable characteristics that can be identified by the predefined pattern will be obvious to those of ordinary skill in the art having the benefit of this disclosure.

Advantageously, embodiments of the disclosure can be used as interactive and morphable game pieces with electronic devices. Embodiments of the disclosure contemplate that the displays of many electronic devices, including tablet computers, laptop computers with touch screens, sufficiently large smartphones, and other devices, can serve as highly interactive game boards. Advantageously, the optical transmission devices transmit light from the display of the device to one or more surfaces of the passive display accessory. Where predefined patterns of electrically conductive elements communication the location of the passive device accessory to the electronic device, images of faces, game components, characters, and the like can be displayed by the image transmission portion of the passive display accessory as a function of location.

In one or more embodiments, the passive display accessory is manufactured from an electrically conductive material. Where this is the case, the electronic device can detect whether a user is touching the passive display accessory. For example, when the user touches the electrically conductive material, it ties the material to electrical ground. However, when the user is not touching the electrically conductive material, it is “floating” in that it is not tied to a predefined electrical potential. Advantageously, electronic devices with touch-sensitive displays can determine whether the user is touching the passive display accessory in this manner to project different images at the image transmission portion of the passive display accessory as a function of user touch.

Embodiments of the present invention provide an electronic device and a passive display accessory that can be placed along a display of the electronic device. In one or more embodiments, the passive display accessory is configured to be detachable from the display so that it can be moved around, for example, as a game piece. However, in one or more embodiments adhesion devices such as electrostatically adhesive layers can be applied to the optically transparent major face of the base so that the passive display accessory can be configured for a temporarily permanent attachment to the display of the electronic device.

In one or more embodiments, the electronic device is equipped with a touch-sensitive surface, such as a touch-sensitive display, which creates and monitors surface electromagnetic fields. While a display is one example of a touch-sensitive surface, other the passive display accessory can be used with other touch-sensitive surfaces, including touch pads. In one embodiment, the touch-sensitive surface includes a capacitive field sensor. In another embodiment, the touch sensitive surface includes a magnetic field sensor. The passive display accessory can be placed against the touch-sensitive surface and can be selectively removed from the touch-sensitive surface. The passive display accessory can be configured in different shapes, including as a figurine, as a game character, as a game piece, or with other appearances.

One or more processors of the electronic device can be configured to identify one or more of the type of passive display accessory, the location of the passive display accessory along a display, the physical configuration of the passive display accessory, and/or the geometric orientation in three-dimensional space of the passive display accessory along an axis oriented substantially orthogonally with the display. In one or more embodiments, the one or more processors may then adapt the operating mode of the display in response to this identification. For example, in one embodiment, the display presents a predefined image at a location where the passive display accessory is disposed along this display. This predefined image can be a function of any of the type of passive display accessory, the location of the passive display accessory along a display, the physical configuration of the passive display accessory, and/or the geometric orientation in three-dimensional space of the passive display accessory.

In one or more embodiments, when the optically transparent major face of the passive display accessory is placed against the display, the one or more conductive elements disposed along the optically transparent major face in a predefined pattern deliver a signature signal to the electronic device via the touch sensor of the touch-sensitive surface. In one embodiment, the signature signal is temporal in nature, as the electric field perturbations of the one or more conductive elements transition to a steady state. The temporal signature signal can define a characteristic amplitude, surface area, and time-based signature. The one or more processors of the electronic device, operating in tandem with the touch sensor of the touch-sensitive surface, can identify the passive display accessory from the temporal signature signal. Upon identification, an adaptation module is then configured to present one or more images beneath the passive display accessory in response to this identification.

In one embodiment, when the optically transparent major face of the passive display accessory is initially placed against the display of the electronic device, the one or more processors analyze a signature signal detected by the touch-sensitive surface due to the placement of the one or more conductive elements along the optically transparent major face. The signature signal can include characteristics such as a signal amplitude, a signal surface area, a characteristic decay, a characteristic slope, or a characteristic change in slope. From the temporal signal, the one or more processors detect the presence of the passive display accessory. In one embodiment, this detection can include an analysis of the location or configuration of the one or more conductive elements as well, which may indicate the location and orientation of the passive display accessory. The one or more processors then use this information to select an image to deliver through the passive display accessory as a function of one or more of the identity, the location, the orientation, and/or the physical configuration of the passive display accessory.

In one embodiment, a touch-sensitive display is backlit or otherwise illuminated such that light is projected toward the optically transparent major face when the passive display accessory is placed along the touch-sensitive display. Accordingly, in one embodiment the passive display accessory is configured to employ this light to present the same image on the image transmission portion. In one embodiment, multiple passive display accessories can be attached to the display of the electronic device simultaneously. For example, in one embodiment described below, a plurality of passive display accessories can be disposed along the surface of a tablet computer so that they can be used as chess pieces.

In one or more embodiments, the passive display accessory includes one or more optical transmission devices, such as optic fibers, that present an image on the image transmission portion of the passive display accessory. As noted, in one or more embodiments the position and/or orientation in three-dimensional space can be determined. Accordingly, movement of the passive display accessory can be determined as well. User interaction with the passive display accessory can also be monitored. The electronic device can be equipped with voice recognition or other features so that interaction with the environment can be monitored as well. In one or more embodiments, the passive display accessory can be equipped with optics coupling mechanisms to target light source pixel sources and eliminating cross-talk/interference from other pixels as well. Advantageously, embodiments of the disclosure provide improved user interfaces for gaming and other applications, which are highly desirable for portable electronic devices.

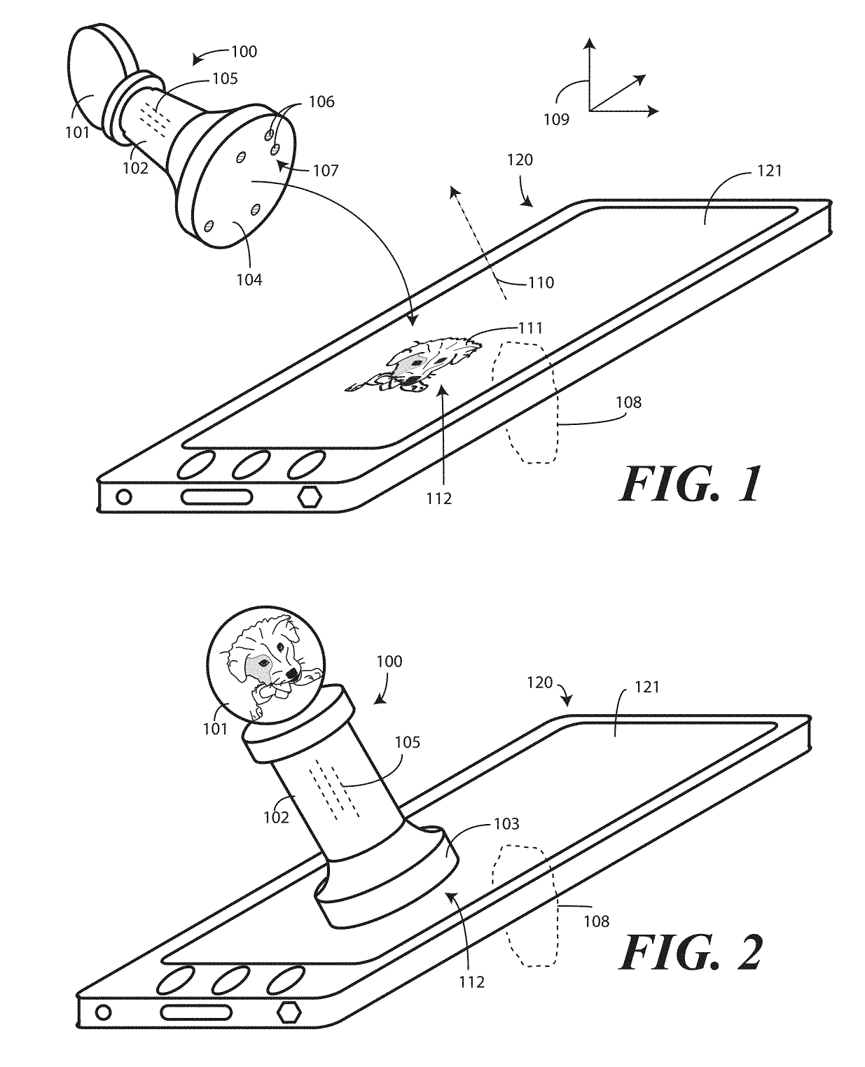

Turning now to FIG. 1, illustrated therein is one explanatory passive display accessory 100 and one explanatory electronic device 120 configured in accordance with one or more embodiments of the disclosure. The electronic device 120 of FIG. 1 is a portable electronic device, and is shown as a smart phone for illustrative purposes. However, it should be obvious to those of ordinary skill in the art having the benefit of this disclosure that other electronic devices may be substituted for the explanatory smart phone of FIG. 1. For example, the electronic device 120 could equally be a palm-top computer, a tablet computer, or other device.

The passive display accessory 100 comprises an image transmission portion 101, a body 102, and a base 103. The base 103 includes an optically transparent major face 104. As will be shown in more detail with reference to FIGS. 4, 6, and 7 below, in one or more embodiments the body 102 comprises one or more optical transmission devices 105 that deliver light received at the optically transparent major face to the image transmission portion. In one or more embodiments, one or more conductive elements 106 are disposed along the optically transparent major face 104 in a predefined pattern 107. In one or more embodiments, the one or more conductive elements 106 cause electromagnetic field perturbations 108 at a touch-sensitive display 121 of the electronic device 120 when the base 103 is proximately located with the touch-sensitive display 121.

The passive display accessory 100 can be configured in any number of configurations. For example, in the illustrative embodiment of FIG. 1, the image transmission portion 101, the base 103, and the body 102 defining a figurine. In this illustrative embodiment, the figurine is configured as a game piece, as the passive display accessory 100 resembles a generic game piece, with the image transmission portion 101 defining a head of the game piece. Passive display accessories configured in accordance with embodiments of the disclosure can be configured in other ways as well. For example, the passive display accessory 100 could be configured as a character, a holiday ornament, a holiday icon, a person, cartoon character, mascot, vehicle, house, or with any other appearance.

In one or more embodiments, the passive display accessory 100 can be manufactured as a single, unitary component, with the image transmission portion 101, the base 103, and the body 102 manufactured as a single part. For example, in one embodiment the passive display accessory 100 is manufactured in an injection molding process to allow for the simple, one-piece construction shown in FIGS. 1 and 2. In other embodiments, the passive display accessory 100 could be assembled from multiple pieces. The passive display accessory can be clear, transparent, pellicud, or can have a color, such as when manufactured from a colored plastic. In other embodiments, the passive display accessory can be manufactured from different materials. For example, in another embodiment the passive display accessory 100 is manufactured from glass. Other configurations and materials for manufacturing the passive display accessory 100 will be obvious to those of ordinary skill in the art having the benefit of this disclosure.

In one or more embodiments, the passive display accessory 100 is configured as an accessory that a user can conveniently attach and detach to the touch-sensitive display 121 of the electronic device 120. It should be noted that while a touch-sensitive display 121 is described with the electronic device 120 for illustration, the passive display accessory 100 can be used with non-touch-sensitive displays as well. Where a touch-sensitive display is used, in one embodiment the touch-sensitive display 121 comprises an electromagnetic field sensor that is configured to detect the presence of an object—such as a user's finger or conductive stylus—proximately located with touch-sensitive display 121.

The passive display accessory 100 shown in the illustrative embodiment of FIG. 1 is a “passive” device. The term “passive” is used because the passive display accessory 100 does not need a power source or active electronic components, such as amplifiers, power switches, or control devices, to deliver user actuation input signals to the touch-sensitive display 121. Any energy received or used by the passive display accessory 100 instead comes from either the electronic device 120 or a user, as will be described in more detail below.

In one or more embodiments, the passive display accessory 100 is mechanically configured to be attachable and detachable from the touch-sensitive display 121. In one simple embodiment, a user simply places the optically transparent major face 104 of the base 103 against the touch-sensitive display 121. However, in other embodiments, such as that described with reference to FIG. 4 below, an electrostatically adhesive element can be used to temporarily retain the optically transparent major face 104 of the base 103 against the touch-sensitive display 121. This latter embodiment advantageously allows a user the freedom to touch the touch-sensitive display 121 without inadvertently sliding or knocking over the passive display accessory 100. In one or more embodiments, the passive display accessory 100 can be tethered or otherwise connected to the electronic device 120 to prevent it from being misplaced.

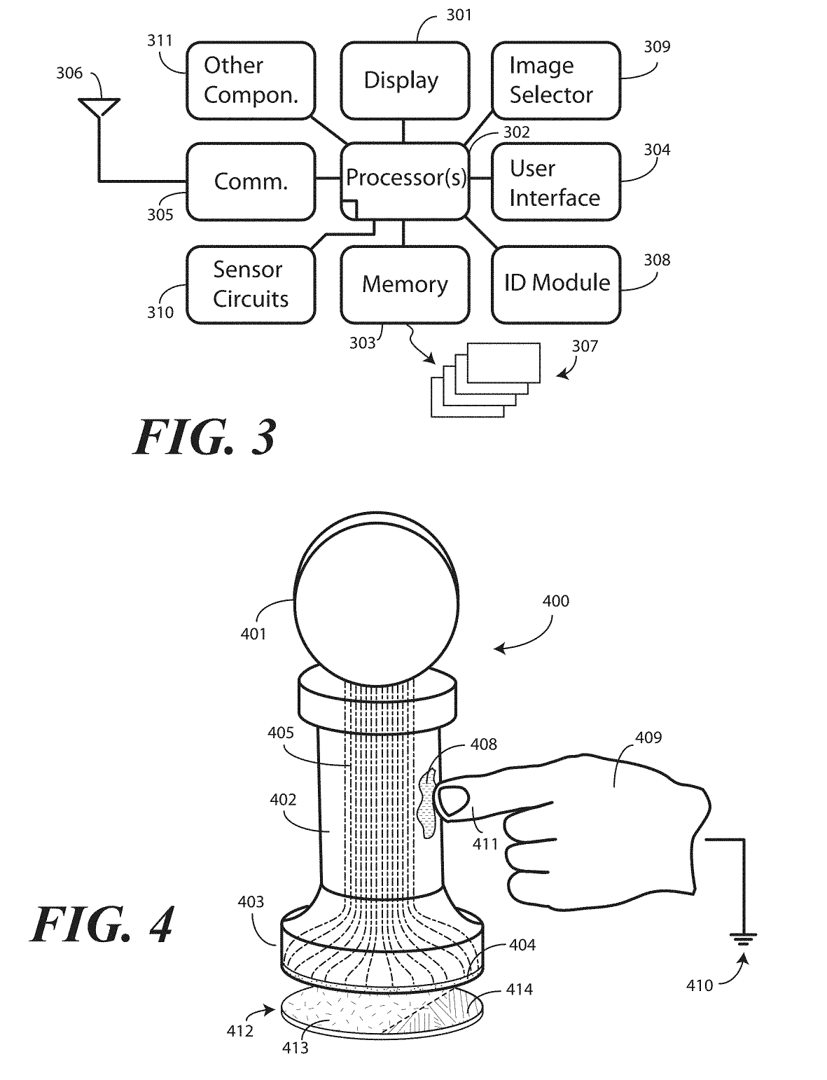

As will be described in more detail below with reference to FIG. 3, in one or more embodiments the electronic device 120 includes one or more processors that are operable with the touch-sensitive display 121, which can include a capacitive touch sensor and its corresponding electromagnetic field sensor. In one or more embodiments, the one or more conductive elements 106 are configured to deliver a signature signal in the form of electromagnetic field perturbations 108 to the touch-sensitive display 121 when the optically transparent major face 104 is proximately located with the touch-sensitive display 121. In one or more embodiments, the signature signal is temporal because it changes over time. The one or more conductive elements 106 are, in one embodiment, arranged in a characteristic configuration in accordance with a predetermined overall pattern, pad shape, or pad size. In one or more embodiments, the one or more conductive elements 106 are configured to interact with the electromagnetic field sensor of the touch-sensitive display (121).

For example, in one embodiment the one or more conductive elements 106 comprise conductive pads disposed along the underside of the passive display accessory 100 that interact with the electromagnetic field sensor of the touch-sensitive display 121. The conductive pads can be oriented in a predefined pattern or configuration, i.e., at specific locations along the passive display accessory 100, and can have predetermined sizes and shapes, or combinations thereof, so as to interact with the electromagnetic field sensor so as to deliver the electromagnetic field perturbations 108 to the touch-sensitive display 121. In one embodiment, the one or more conductive elements 106 are manufactured from an optically transparent material. For example, indium-tin-oxide can be printed along the optically transparent major face 104 of the base 103 in one embodiment. In another embodiment, a carbon elastomeric material or other conductive materials to form the one or more conductive elements 106. Other materials will be obvious to those of ordinary skill in the art having the benefit of this disclosure. Further, a protective layer, such as a thin layer of thermoplastic material may be placed over the one or more conductive elements 106 as well.

In one embodiment, the one or more processors of the electronic device 120 analyze the electromagnetic field perturbations to identify one or more of the passive display accessory 100, its location along the touch-sensitive display 121, or its geometric orientation in three-dimensional space 109 along an axis 110 oriented substantially orthogonally with the touch-sensitive display 121. For example, where multiple passive display accessories are used as game pieces, with one being a king and one being a pawn, in one or more embodiments the one or more processors of the electronic device 120 can distinguish the king from the pawn to identify a particular passive display accessory by analyzing the electromagnetic field perturbations 108. This can be accomplished in a variety of ways, such as determining the x-y planar area associated with the electromagnetic field perturbations 108, the locations, shapes, and magnitudes of peaks in the electromagnetic field perturbations 108, the time-based decay of peaks in the electromagnetic field perturbations 108, and so forth.

While analysis of the electromagnetic field perturbations 108 is one method of identifying the passive display accessory 100, it will be clear to those of ordinary skill in the art embodiments of the invention are not so limited. Other identification techniques may be substituted. For instance, piezoelectric crystals can be substituted for the one or more conductive elements 106. Accordingly, the one or more processors of the electronic device 120 can be configured to analyze vibrational signals delivered by the crystals to the touch-sensitive display 121. Alternatively, magnetometers can be substituted for the one or more conductive elements 106. Accordingly, the one or more processors of the electronic device 120 can be configured to analyze variations in magnetic fields in relative to the touch-sensitive display 121. As another example, optical couplers can be substituted for the one or more conductive elements 106. Accordingly, the one or more processors of the electronic device 120 can be configured to analyze variations in the wavelength of light or reflectivity relative to the touch-sensitive display 121. Other techniques of identifying the passive display accessory 100 will be obvious to those of ordinary skill in the art having the benefit of this disclosure.

Using the electromagnetic field perturbations 108, the resulting temporal characteristics can then be compared with predefined models, tolerances, or threshold limits to uniquely identify the type of passive display accessory 100. For example, one type could be a family of chess game pieces, while another type are Monopoly™ game pieces, and a third type are checkers game pieces. From type identification, the one or more processors of the electronic device 120 can select images 111 and the location 112 of those images 111 along the touch-sensitive display 121 for presentation on the image transmission portion 101 as will be shown in FIG. 2 below.

The x-y planar location of the electromagnetic field perturbations 108 can be detected across the touch-sensitive display 121 and can be a characteristic used to identify the attachment location and orientation of the passive display accessory 100. For instance, in addition to performing analysis on the electromagnetic field perturbations 108 to identify the passive display accessory 100, the one or more processors of the electronic device 120 can be configured to determine the location of the electromagnetic field perturbations 108 and use the x-y planar location information to determine the placement and orientation of the passive display accessory 100. Additionally, the electromagnetic field perturbations 108 can be analyzed to a geometric orientation, e.g., whether the image transmission portion 101, is facing to the right or the left, of the passive display accessory 100 in three-dimensional space 109 along an axis 110 oriented substantially orthogonally with the touch-sensitive display 121. This information can be used to select which image 111 is presented on the touch-sensitive display 121, as well as the location 112 of that image 111 as well. For example, where the sensor disposed within the touch-sensitive display 121 is a capacitive sensor, however, the one or more processors of the electronic device 120 can be configured to determine location directly from electromagnetic field perturbation signals delivered by the capacitive sensor.

In this illustrative embodiment, the image transmission portion 101 is disc-shaped. However, the image transmission portion 101 can be configured in other ways as well. For example, in another embodiment, the image transmission portion 101 is configured as a sphere. In another embodiment, the image transmission portion 101 is configured as a cube. In another embodiment, the image transmission portion is configured as a poly-sided three-dimensional shape. Still other configurations will be obvious to those of ordinary skill in the art having the benefit of this disclosure.

As shown in FIG. 1, no image is present on the image transmission portion 101, despite the fact that an image 111 is being presented on the touch-sensitive display 121. This is true because the optically transparent major face 104 of the base 103 is not proximately located with the touch-sensitive display 121.

By contrast, turning now to FIG. 2, the passive display accessory 100 has been placed against the touch-sensitive display 121. More specifically, the optically transparent major face (104) of the base 103 has been proximately located with the touch-sensitive display 121 by abutting the optically transparent major face (104) of the base 103 with the touch-sensitive display 121. When this occurs, the one or more optical transmission devices 105 of the body 102 of the passive display accessory 100 receive light at the optically transparent major face (104) of the base 103 and deliver the same to the image transmission portion 101. Accordingly, the image (111) presented on the touch-sensitive display 121, which in this illustration is a picture of the user's dog, Buster, is presented on the image transmission portion. In this illustrative embodiment, the image (111) is presented at the location 112 of the base 103 of the passive display accessory 100 due to the fact that the one or more processors of the electronic device 120 have determined the location 112 by analyzing the electromagnetic field perturbations 108 as previously described.

Turning now to FIG. 3, illustrated therein is a schematic block diagram 300 of one explanatory electronic device (120) configured in accordance with one or more embodiments of the disclosure. As noted, in one or more embodiments the electronic device (120) includes a display 301, which may optionally be touch-sensitive. In one embodiment where the display 301 is touch-sensitive, the display 301 can serve as a primary user interface 304 of the electronic device (120). Users can deliver user input to the display 301 of such an embodiment by delivering touch input from a finger, stylus, or other objects disposed proximately with the display. In one embodiment, the display 301 is configured as an organic light emitting diode (OLED) display. However, it should be noted that other types of displays would be obvious to those of ordinary skill in the art having the benefit of this disclosure. In one embodiment, the display 301 includes an electroluminescent layer or light-emitting diode (LED) backlighting layer disposed beneath the display 301 to project light through the display 301. The display 301 layer can adaptively present text, graphics, images (111), user actuation targets, data, and controls along the display surface.

In one embodiment, the electronic device (120) includes one or more processors 302. In one embodiment, the one or more processors 302 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device (120). Each of the application processor and the auxiliary processor(s) can be configured to process and execute executable software code to perform the various functions of the electronic device (120). A storage device, such as memory 303, can optionally store the executable software code used by the one or more processors 302 during operation.

In this illustrative embodiment, the electronic device 120 also includes a communication circuit 305 that can be configured for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks.

The communication circuit 305 may also utilize wireless technology for communication, such as, but are not limited to, peer-to-peer or ad hoc communications such as HomeRF, Bluetooth and IEEE 802.11 (a, b, g or n), and other forms of wireless communication such as infrared technology. The communication circuit 305 can include wireless communication circuitry, one of a receiver, a transmitter, or transceiver, and one or more antennas 306.

In one embodiment, the one or more processors 302 can be responsible for performing the primary functions of the electronic device (120). For example, in one embodiment the one or more processors 302 comprise one or more circuits operable with the user interface 304, which can include the display 301, to present, images, video, or other presentation information to a user. The executable software code used by the one or more processors 302 can be configured as one or more modules 307 that are operable with the one or more processors 302. Such modules 307 can store instructions, control algorithms, logic steps, and so forth.

An identification module 308 can be operable with the one or more processors 302. In one or more embodiments, the identification module 308 is configured to detect and identify the passive display accessory (100) from the electromagnetic field perturbations (108) as previously described.

In one or more embodiments, an image selector 309 is also operable with the one or more processors 302. The image selector 309 can generate commands or execute control operations based on information received from the identification module 308. For example, the image selector 309 can select an image to be presented on the display 301 as a function of the identification of the passive display accessory (100) in one embodiment. In another embodiment, the image selector 309 can select an image to be presented on the display 301 and a location of the presentation of the image in response to input from the identification module such as the location across the display 301 where the passive display accessory (100) is located and/or the geometric orientation of the passive display accessory (100) in three-dimensional space (109). For instance, the image selector 309 may select a stop sign as the image when the passive display accessory (100) is disposed in a first location and is facing left. By contrast, the image selector 309 may select a green light or a yield sign when the passive display accessory (100) is disposed in that location and is facing right.

Other sensors 310 and other components 311 can be included as well. For example, the other sensors 310 may include a microphone, a speaker, and a user interface component such as a button. The other sensors 310 can include a touch pad sensor, a touch screen sensor, a capacitive touch sensor, and one or more switches. The other sensors 310 can also include audio sensors and video sensors (such as a camera). The other sensors 310 can also include motion detectors, such as one or more accelerometers or gyroscopes. The motion detectors can detect movement, and direction of movement, of the electronic device (120) by a user. The other sensors 310 can also be used to detect gestures. For example, the other sensors 310 can include one or more proximity sensors that detect the gesture of a user waving a hand above the display 301. In yet another embodiment, the accelerometer can detect gesture input from a user lifting, shaking, or otherwise deliberately moving the electronic device (120). It should be clear to those of ordinary skill in the art having the benefit of this disclosure that additional sensors can be included with the other sensors 310 shown in FIG. 3.

Other components 311 operable with the one or more processors 302 can include output components such as video outputs, audio outputs, and/or mechanical outputs. Examples of output components alarms and/or buzzers and/or a mechanical output component such as vibrating or motion-based mechanisms. Still other components will be obvious to those of ordinary skill in the art having the benefit of this disclosure.

It is to be understood that FIG. 3 is provided for illustrative purposes only and for illustrating components of one electronic device (120) in accordance with embodiments of the disclosure, and is not intended to be a complete schematic diagram of the various components required for an electronic device. Therefore, other electronic devices in accordance with embodiments of the disclosure may include various other components not shown in FIG. 3, or may include a combination of two or more components or a division of a particular component into two or more separate components, and still be within the scope of the present disclosure.

Turning now to FIG. 4, illustrated therein is another passive display accessory 400 configured in accordance with one or more embodiments of the disclosure. As before, the passive display accessory 400 comprises an image transmission portion 401, a body 402, and a base 403. The base 403 includes an optically transparent major face 404.

In one or more embodiments, the body 402 comprises one or more optical transmission devices 405 that deliver light received at the optically transparent major face 404 to the image transmission portion 401. In this illustrative embodiment, the one or more optical transmission devices 405 comprise printed fiber optic transmission elements. For example, in this illustrative embodiment, each optical transmission device 405 comprises a printed optical fiber. Using three-dimensional printing technology, printed optical fibers can be easily constructed in contrast to the complex process of creating fibers through heating and extrusion.

In this illustrative embodiment, one or more of the body 402, the base 403, or the image transmission portion 401 is manufactured from an electrically conductive material 408. The electrically conductive material 408 can be configured as a coating on one or more of the body 402, the base 403, or the image transmission portion 401. Alternatively, the electrically conductive material 408 can be integrated into one or more of the body 402, the base 403, or the image transmission portion 401 itself. For example, where the passive display accessory 400 is manufactured from plastic, the plastic can be impregnated with metal, carbon, or other electrically conductive materials.

The use of an electrically conductive material 408 advantageously allows the identification module (308) of an electronic device (120) to determine whether a user 409 is touching the passive display accessory 400. Note that the determination of whether a user 409 is touching the passive display accessory 400 is distinct from the determination of the location, type of passive display accessory, and so forth by analyzing the electromagnetic field perturbations (108) as previously described. Thus, identification information can be determined regardless of whether the user 409 is touching the passive display accessory 400. The inclusion of the electrically conductive material 408 therefore adds an additional layer of identification granularity compared to the use of conductive pads disposed along the underside of the passive display accessory 900 that interact with the electromagnetic field sensor of the touch-sensitive display (121).

Accordingly, when the electrically conductive material 408 is used, and when the user 409 is touching the electrically conductive material 408, the same is tied to electrical ground 410 through the user's fingers 411. By contrast, when the user 409 is not touching the electrically conductive material 408, the passive display accessory 400 floats due to not being coupled to any defined potential. In one or more embodiments, the image selector (309) of the electronic device (120) can select an image and or its location as a function of whether the user 409 is touching the passive display accessory 400.

In one or more embodiments, an optional attachment layer 412 can be attached to the optically transparent major face of the base 403. In one embodiment, the attachment layer 412 comprises a plastic layer, such as a plastic film, that is optically transparent. In one embodiment, the optional attachment layer 412 comprises an electrostatically adhesive element 413 to electrostatically adhere the optically transparent major face of the base 403 to a display or other glass or metal surface. Advantageously, the inclusion of the electrostatically adhesive element 413 keeps the passive display accessory 400 from sliding around when proximately located with a display.

In one or more embodiments, the inclusion of the attachment layer 412 performs functions other than simply keeping the passive display accessory 400 from sliding around. Embodiments of the disclosure contemplate that older touch-sensitive display technologies are only going to detect the base 403 of the passive display accessory 400 when the passive display accessory 400 comprises the electrically conductive material 408 and the user 409 is touching the same. As noted, once the fingers 411 are removed, the passive display accessory 400 floats. Older touch screens will loose the “image” created by the one or more conductive elements disposed along the base 403. Thus, advantageously, the inclusion of the attachment layer 412 keeps the passive display accessory 400 securely locate at a location on the display until the user 409 moves it. This allows the touch screen to remember the last location. Moreover, the last location won't change while the passive display accessory 400 is not touched, thereby allowing the electronic device to use the last known position of the passive display attachment to figure out where to present an image on the display.

In yet another embodiment, the electrostatically adhesive element 413 is combined with electrically conductive material 414. This combination allows the conductive “fingerprint” that identifies the passive display accessory 400 to be included with the electrostatically adhesive element 413 that is doing the job of keeping the passive display accessory 400 attached to the touch-sensitive surface. This can simplify manufacturing, as well as making sure that all parts of the fingerprint pattern make good physical contact with the touch-sensitive surface. Since adhesive can get dirty, in one or more embodiments one or both of the electrostatically adhesive element 413 and/or the electrically conductive material 414 can be configured as a series of uniquely spaced “dots” disposed around the edge of the attachment layer 412, thereby leaving the optically transmissive portions in the middle and free from this contamination. Having a conductive ring around the edge of the attachment layer 412, or the optically transparent major face of the base 403 where no attachment layer 412 is used, also makes it that much easier to “paint” a conductive coating on the passive display accessory 400 and make sure this coating has good contact with the base 403.

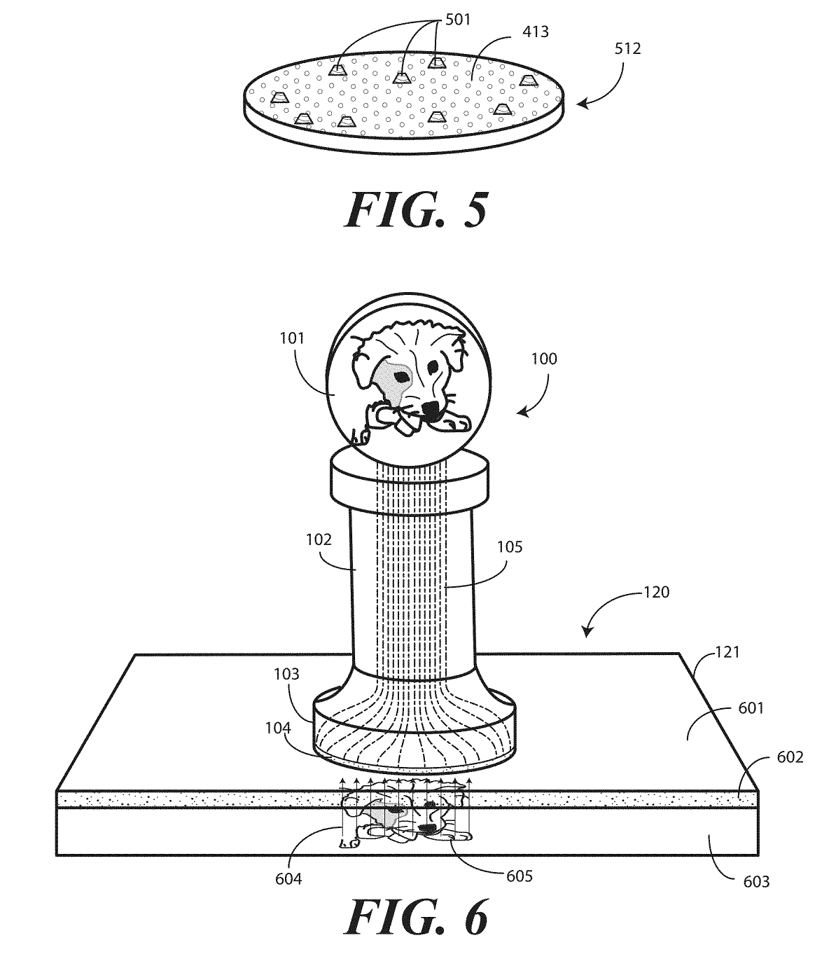

Turning now to FIG. 5, in one embodiment an attachment layer 512 includes both the electrostatically adhesive element 413 and the one or more conductive elements 501 identifying the passive display accessory to which the attachment layer 512 is attached. Accordingly, the conductive pattern defined by the one or more conductive elements 501 not only identifies the position and orientation of the passive display accessory to which it is attached, but also includes a “fingerprint” that identifies the passive display attachment. In one or more embodiments, the one or more conductive elements 501 are disposed in a predefined pattern and cause electromagnetic field perturbations (108) as previously described.

Turning now to FIG. 6, illustrated therein is one explanatory system 600 configured in accordance with one or more embodiments of the disclosure. The system 600 includes an electronic device 120 and a passive display accessory 100. The electronic device 120 includes a touch-sensitive display 121 and one or more processors (302) operative with the touch-sensitive display 121. In this illustrative embodiment, the touch-sensitive display 121 includes a lens 601 or rigid fascia, e.g., a layer of reinforced glass, a touch sensor 602, e.g., a capacitive touch sensor, and an active display matrix 603 to project and/or reflect light 604 in the form of one or more images through the lens 601.

The passive display accessory 100 includes an image transmission portion 101, a base 103 comprising an optically transparent major face 104, and a body 102 coupling the base 103 to the image transmission portion 101. The body 102 comprises one or more optical transmission devices 105 optically coupling the optically transparent major face 104 to the image transmission portion 101.

As shown in FIG. 6, the active display matrix 603 is delivering light 604 in the form of an image 605 of Buster through the lens 601 of the touch-sensitive display 121. When this occurs, the one or more optical transmission devices 105, which are printed optical fibers in this embodiment, translate and deliver the light 604 from the image 605 presented on the touch-sensitive display 121 to the image transmission portion 101 to present the image 605 on the image transmission portion 101.

Where the optically transparent major face 104 of the base 103 include one or more conductive elements in a predefined pattern, the one or more processors of the electronic device 120 can identify the passive display accessory 100 from electric field perturbations at the touch-sensitive display 121 when the base 103 of the passive display accessory 100 is proximately located with the touch-sensitive display 121. Additionally, the one or more processors can identify a location of the passive display accessory 100 is disposed along the touch-sensitive display 121 from electric field perturbations at the touch-sensitive display 121 when the base 103 of the passive display accessory 100 is proximately located with the touch-sensitive display 121. By presenting different images with the touch-sensitive display 121, different images become visible on the image transmission portion 101. These images can be selected a function of the type of passive display accessory, the location of the passive display accessory, the orientation of the passive display accessory in three-dimensional space, or other factors.

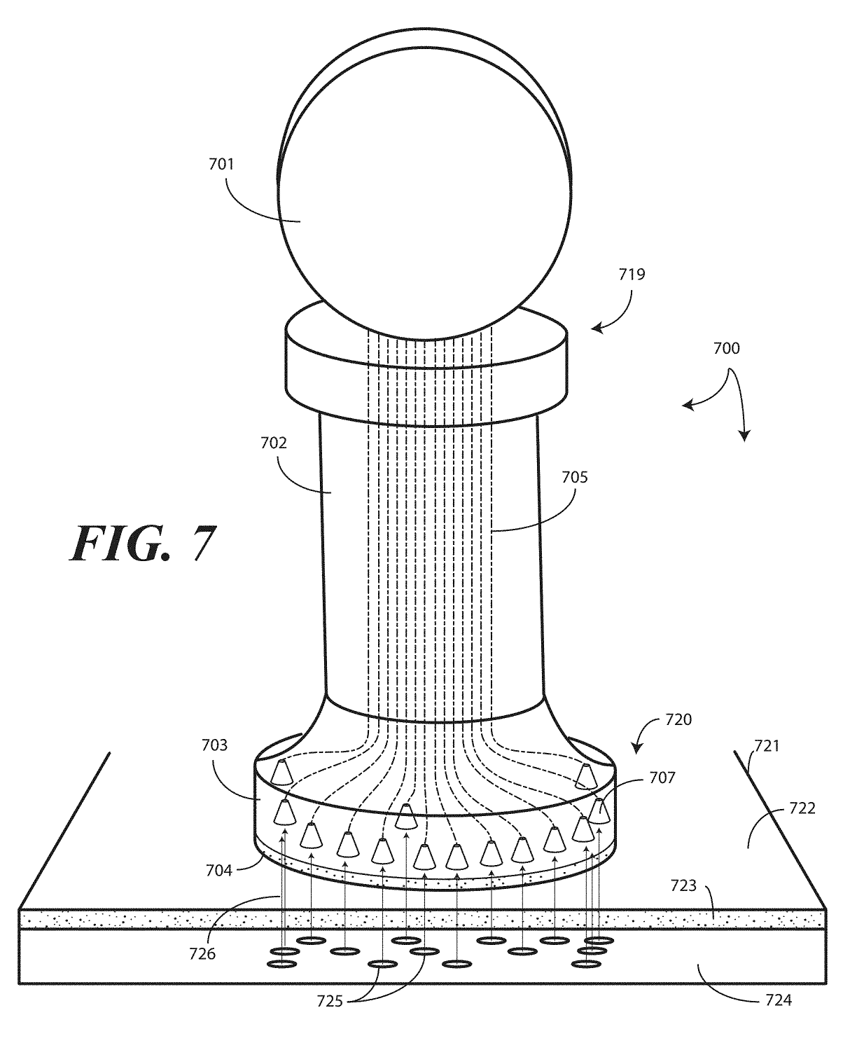

Turning now to FIG. 7, illustrated therein is another explanatory system 700 configured in accordance with one or more embodiments of the disclosure. The system 700 includes an electronic device 720 and a passive display accessory 719. The electronic device 720 includes a touch-sensitive display 721 and one or more processors operative with the touch-sensitive display 721. In this illustrative embodiment, the touch-sensitive display 721 includes a lens 722, a touch sensor 723, and an active display matrix 724 having one or more pixels 725 to project and/or reflect light 726 in the form of one or more images through the lens 722.

The passive display accessory 718 includes an image transmission portion 701, a base 703 comprising an optically transparent major face 704, and a body 702 coupling the base 173 to the image transmission portion 701. The body 702 comprises one or more optical transmission devices 705 optically coupling the optically transparent major face 704 to the image transmission portion 701. In this illustrative embodiment, the one or more optical transmission devices 705 comprise conventional optical fibers. However, printed optical fibers can be used as well.

In this embodiment, the base 703 further includes one or more optical alignment devices 707. Each optical alignment device 707 in this embodiment is configured as a conical light pipe that receives the light 726 at a first end and concentrates the light 726 as the light 726 moves from the first end to the second end. Accordingly, the optical alignment devices 707 concentrate and “funnel” the light received from each pixel 725 to each optical transmission device 705, thereby improving the resolution of images at the image transmission portion 701. The inclusion of optical alignment devices 707 is particularly advantageous when the lens 722 of the touch-sensitive display 721 is thick. In this illustrative embodiment, the one or more optical alignment devices 707 are disposed in the base 703 and are coupled to the fiber optic cables on a one-to-one basis.

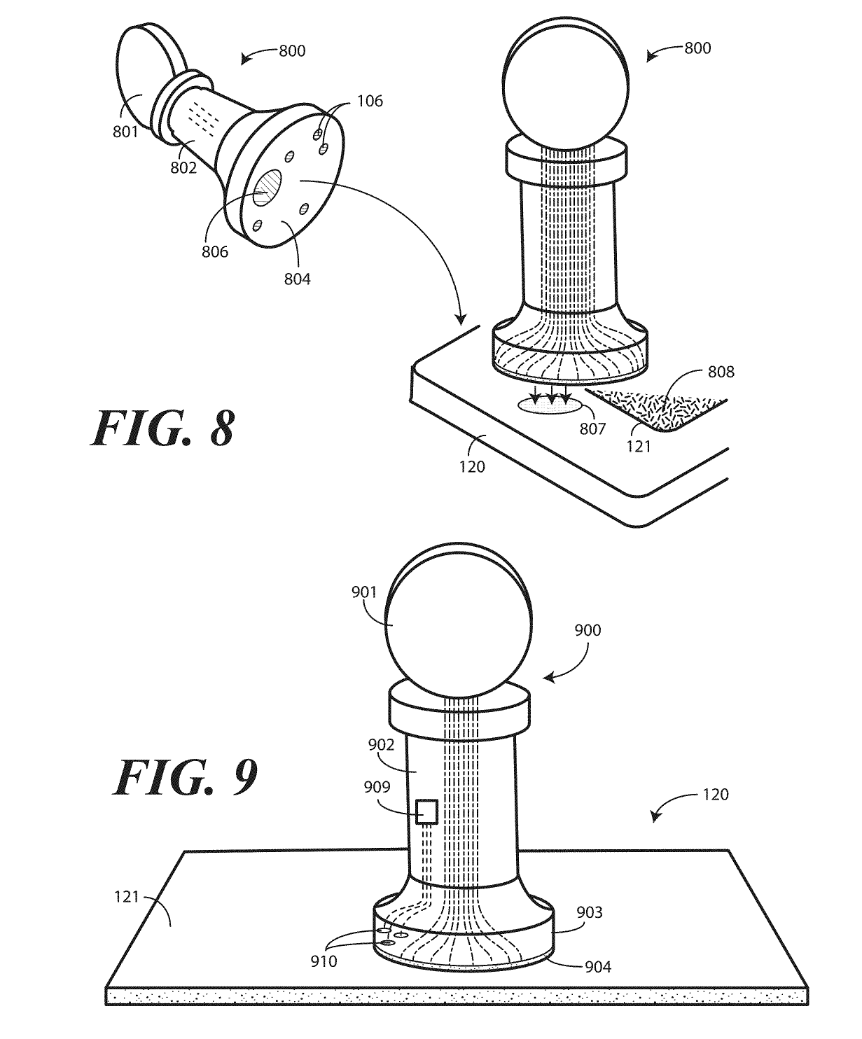

Turning now to FIG. 8, illustrated therein is another passive display accessory 800 configured in accordance with one or more embodiments of the disclosure. As before, the passive display accessory 800 comprises an image transmission portion 801, a body 802, and a base 803. The base 803 includes an optically transparent major face 804.

As with previous embodiments, this passive display accessory 800 includes one or more conductive elements 106 are configured to deliver a signature signal in the form of electromagnetic field perturbations (108) to a touch-sensitive display 121 when the optically transparent major face 804 is proximately located with the touch-sensitive display 121. In this illustrative embodiment, the optically transparent major face 804 is also encoded with a device actuation key 806. In one embodiment, the device actuation key 806 comprises biometric information, such as fingerprint or other identifying information, that can be communicated to a biometric sensor 807 to provide an authentication or handshake with the electronic device 120.

Thus, as shown in FIG. 8, when the device actuation key 806 is placed near the biometric sensor 807 of the electronic device 120, in one or more embodiments biometric data represented by the device actuation key 806 is delivered to the biometric sensor 807. In one embodiment, this transfer of data can cause the electronic device 120 to transition from a first mode of operation to a second mode of operation. For example, the electronic device 120 may initially be in a locked mode of operation. However, when the device actuation key 806 is placed near the biometric sensor 807 of the electronic device 120, in one or more embodiments the electronic device 120, upon verifying the biometric data, transitions the electronic device 120 to an unlocked mode of operation. In another embodiment, the electronic device 120 may initially be in a low power or sleep mode of operation. However, when the device actuation key 806 is placed near the biometric sensor 807 of the electronic device 120, in one or more embodiments the electronic device 120, upon verifying the biometric data, transitions the electronic device 120 to an active mode of operation.

The device actuation key 806 can be configured in a number of different ways. In one illustrative embodiment, the device actuation key 806 can comprise one or more conductive elements, such as conductive pads, disposed along the underside of the passive display accessory 800 in a predefined pattern. Alternatively, the device actuation key 806 can comprise a surface acoustic wave device. In another embodiment, the device actuation key 806 can comprise a plurality of magnetic devices. The magnetic devices can have different inherent magnetic fields, thereby delivering a unique signature to the electronic device 120. Additionally, the device actuation key 806 can comprise non-biometric, unique data that causes the electronic device 120 to transition modes, but does not require the use of biometric data. The device actuation key 806 can be operable with a biometric sensor 807 in one embodiment. However, embodiments of the disclosure are not so limited. In other embodiments, the device actuation key 806 can be operable with the touch-sensitive display 121.

In one or more embodiments, the device actuation key 806 can cause a specific application 808 to launch on the electronic device 120. Illustrating by example, in one embodiment the passive display accessory 800 comprises a game piece. Accordingly, when the device actuation key 806 is placed near the biometric sensor 807 of the electronic device 120, or alternatively near the touch-sensitive display 121 where the device actuation key 806 is configured to work with the display rather than the biometric sensor 807, the one or more processors (302) of the electronic device 120 can launch a specific application 808, such as a game application. Other applications for the device actuation key will be obvious to those of ordinary skill in the art having the benefit of this disclosure.

Turning now to FIG. 9, illustrated therein is another passive display accessory 900 configured in accordance with one or more embodiments of the disclosure. As before, the passive display accessory 900 comprises an image transmission portion 901, a body 902, and a base 903. The base 903 includes an optically transparent major face 904.

As with previous embodiments, this passive display accessory 900 includes one or more conductive elements (106) are configured to deliver a signature signal in the form of electromagnetic field perturbations (108) to a touch-sensitive display 121 when the optically transparent major face 904 is proximately located with the touch-sensitive display 121. In this illustrative embodiment, the passive display accessory 900 includes a memory device 909. In one embodiment, the memory device 909 is a passive memory device that comprises stored data that can be read when energized by an external device such as the electronic device 120. In this illustrative embodiment, the memory device 909 is electrically coupled to one or more memory access terminals 910 by which an external device can deliver energy to the memory device 909 to read the information stored therein. In another embodiment, the passive display accessory 900 can include an energy harvesting circuit configured to draw power from the received electric field from the touch-sensitive display 121 by way of capacitive coupling circuitry. Other configurations for the memory device 909 will be obvious to those of ordinary skill in the art having the benefit of this disclosure.

All types of information can be stored in the memory device 909. Illustrating by example, in one embodiment device actuation information is stored in the memory device 909. When the electronic device 120 reads the device actuation information, in one embodiment it can cause the electronic device 120 to transition from a first mode of operation to a second mode of operation. In another embodiment, the memory device 909 can include application actuation information. When the electronic device 120 reads the application actuation information, it can cause a specific application to launch as previously described. The information stored in the memory device 909 can identify a user, the passive display accessory 900, a character of a game, or other information.

Other applications for the memory device 909 will be obvious to those of ordinary skill in the art having the benefit of this disclosure. For example, in another embodiment, the memory device 909 could store personal identification information suitable for unlocking the electronic device 120. Advantageously, the passive display accessory 900 of this embodiment allows a method for unlocking the electronic device 120 with information that is stored therein, rather than having to store the same information in the “cloud” or in the electronic device 120. The passive display accessory 900 therefore serves as a personal “key” that can be used to unlock or otherwise control the electronic device 120 through an impervious surface such as the lens of a display.

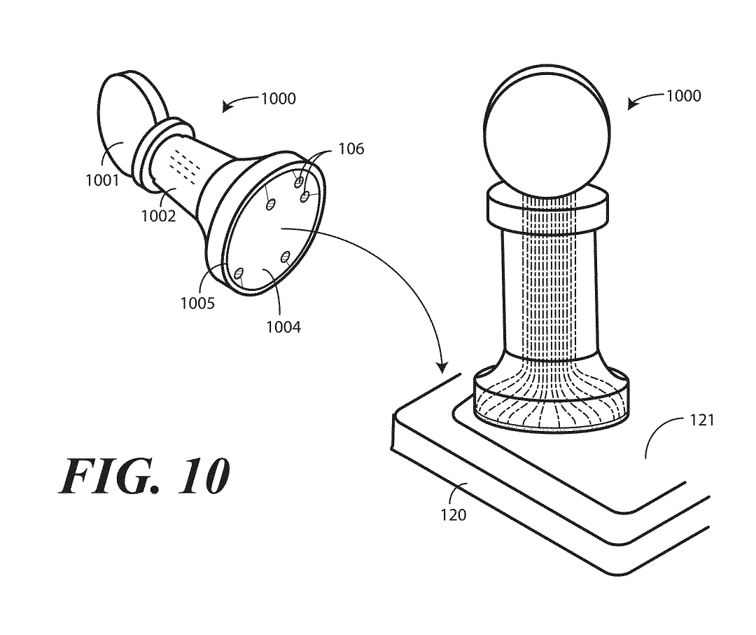

Turning now to FIG. 10, illustrated therein is another passive display accessory 1000 configured in accordance with one or more embodiments of the disclosure. As before, the passive display accessory 1000 comprises an image transmission portion 1001, a body 1002, and a base 1003. The base 1003 includes an optically transparent major face 1004.

As with previous embodiments, this passive display accessory 1000 includes one or more conductive elements 106 are configured to deliver a signature signal in the form of electromagnetic field perturbations (108) to a touch-sensitive display 121 when the optically transparent major face 1004 is proximately located with the touch-sensitive display 121.

Recall from above that in one or more embodiments, the one or more processors of the electronic device 120 could determine whether a user (409) was touching the passive display accessory (400) due to the fact that one or more of the body (402), the base (403), or the image transmission portion (401) includes an electrically conductive material (408). In the embodiment of FIG. 10, the passive display accessory 1000 not need to be touched by a user (409) to deliver a secondary signature beyond the information provided by the one or more conductive elements 106 and their corresponding electromagnetic field perturbations (108). This is true because a conductive ring 1005 is included along the optically transparent major face 1004 of the base 1003. This conductive ring 1005 grounds itself to the touch-sensitive display 121 when the passive display accessory 100 is placed thereon. In this illustrative embodiment, the conductive ring 1005 is coupled to the one or more conductive elements 106 by fine wires. When the optically transparent major face 1004 is proximately located with the touch-sensitive display 121, the one or more conductive elements 106 coupled to the conductive ring 1005 produce a geometric pattern that can be identified by the touch-sensitive display 121. Such an embodiment is useful, for example, where the passive display accessory 1000 is used as a game piece for which a game designer might want to allow freedom of motion. For instance, a re-creation of “old school” electric football where the vibration of a haptics device disposed within the electronic device 120 causes the passive display accessory 1000 to move around along the touch-sensitive display 121 is one explanatory application. Yet another application would be a passive display accessory meant to function as a dye, or more than one passive display accessory acting as a pair of dice, that can be observed by the user, and also observed by the touch screen of the mobile device. Others will be obvious to those of ordinary skill in the art having the benefit of this disclosure.

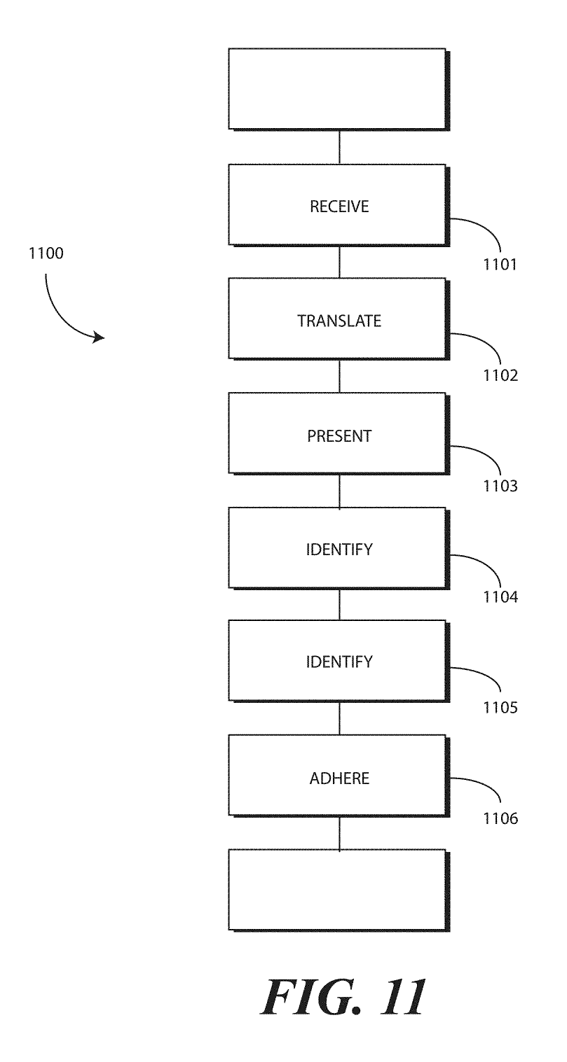

Turning now to FIG. 11, illustrated therein is one explanatory method 1100 in accordance with one or more embodiments of the disclosure. Beginning at step 1101, the method 1100 includes receiving, at an optically transparent base of a passive display accessory, light from an image presented by a display of an electronic device. At step 1102, the method 1100 includes translating, with one or more optical transmission devices, the light to an image transmission portion of the passive display accessory. At step 1103, the method 1100 comprises presenting, with the image transmission portion, the image on a surface of the image transmission portion.

In one or more embodiments, the method 1100 optionally includes, at step 1104, identifying one of a location of the passive display accessory along the display or an identification of the passive display accessory to the electronic device with one or more conductive elements. In one embodiment, the one or more conductive elements are disposed in a predefined pattern along a base of the passive display accessory. In another embodiment, the one or more conductive elements are disposed on an attachment device coupled to the optically transparent major surface of the base. Other configurations for the one or more conductive elements will be obvious to those of ordinary skill in the art having the benefit of this disclosure.

In one embodiment, at step 1105, the method 1100 includes also identifying, to the electronic device, a geometric orientation in three-dimensional space of the passive display accessory along an axis oriented substantially orthogonally with the display. At step 1106, the method optionally includes adhering the passive display accessory along the display with an electrostatic adhesive.

After describing in detail embodiments that are in accordance with the present disclosure, it should be observed that the embodiments reside primarily in combinations of method steps and apparatus components related to delivering images from a display to an image presentation portion of a passive display accessory. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of delivering images through a passive display accessory as described herein. The non-processor circuits may include, but are not limited to, a radio receiver, a radio transmitter, signal drivers, clock circuits, power source circuits, and user input devices. As such, these functions may be interpreted as steps of a method to perform dynamic configuration of passive display accessories. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A passive display accessory for an electronic device, the passive display accessory comprising:
an image transmission portion;
a base comprising an optically transparent major face; and
a body coupling the base to the image transmission portion;
the body comprising one or more optical transmission devices delivering light received at the optically transparent major face to the image transmission portion; and
one or more electrically conductive elements disposed along the optically transparent major face in a predefined pattern.

2. The passive display accessory of claim 1, the one or more electrically conductive elements causing electromagnetic field perturbations at a touch-sensitive display of the electronic device when the base is proximately located with the touch-sensitive display.

3. The passive display accessory of claim 1, the predefined pattern identifying the passive display accessory.

4. The passive display accessory of claim 3, the image transmission portion, the base, and the body defining a figurine.

5. The passive display accessory of claim 1, further comprising a device actuation key disposed along the optically transparent major face.

6. The passive display accessory of claim 1, further comprising a memory device accessible through one or more memory access terminals disposed along the optically transparent major face.

7. The passive display accessory of claim 1, the one or more optical transmission devices comprising printed fiber optic transmission elements.

8. The passive display accessory of claim 1, the one or more optical transmission devices comprising optic fibers.

9. The passive display accessory of claim 8, further comprising one or more optical alignment devices receiving light at a first end and concentrating the light as the light moves from the first end to a second end.

10. The passive display accessory of claim 9, the one or more optical alignment devices disposed in the base and coupled to the optic fibers on a one-to-one basis.

11. The passive display accessory of claim 1, wherein one or more of the body, the base, or the image transmission portion manufactured from an electrically conductive material.

12. The passive display accessory of claim 1, further comprising an electrostatically adhesive element coupled to the optically transparent major face.

13. The passive display accessory of claim 12, the electrostatically adhesive element comprising the one or more electrically conductive elements, the one or more electrically conductive elements identifying the passive display accessory.

14. A system, comprising:
an electronic device comprising a touch-sensitive display and one or more processors operative with the touch-sensitive display; and
a passive display accessory comprising:
an image transmission portion;
a base comprising an optically transparent major face; and
a body coupling the base to the image transmission portion;
the body comprising one or more optical transmission devices optically coupling the optically transparent major face to the image transmission portion; and
the one or more optical transmission devices delivering light from an image presented on the touch-sensitive display to the image transmission portion to present the image on the image transmission portion.

15. The system of claim 14, the passive display accessory further comprising one or more conductive elements disposed along the optically transparent major face in a predefined pattern.

16. The system of claim 14, the one or more processors identifying the passive display accessory from electric field perturbations at the touch-sensitive display when the base of the passive display accessory is proximately located with the touch-sensitive display.

17. The system of claim 14, the one or more processors identifying a location of the passive display accessory is disposed along the touch-sensitive display from electric field perturbations at the touch-sensitive display when the base of the passive display accessory is proximately located with the touch-sensitive display.

18. A method, comprising:
receiving, at an optically transparent base of a passive display accessory, light from an image presented by a display of an electronic device;
translating, with one or more optical transmission devices, the light to an image transmission portion of the passive display accessory;
presenting, with the image transmission portion, the image on a surface of the image transmission portion; and
identifying one of a location of the passive display accessory along the display or an identification of the passive display accessory to the electronic device with one or more conductive elements disposed in a predefined pattern along a base of the passive display accessory.

19. The method of claim 18, further comprising also identifying, to the electronic device, a geometric orientation in three-dimensional space of the passive display accessory along an axis oriented substantially orthogonally with the display.

20. The method of claim 18, further comprising adhering the passive display accessory along the display with an electrostatic adhesive.
